(19) United States
(12) Patent Application Publication
(10) Pub. No.: US 2002/0147922 A1
(43) Pub. Date: Oct. 10, 2002

(54) Software protection mechanism

(76) Inventors: Andreas Hartinger, Erlangen (DE); Martin Kiesel, Poxdorf (DE)

Correspondence Address: Siemens Corporation, Intellectual Property Department, 186 Wood Avenue South, Iselin, NJ, 08830, US

(21) Appl. No.: 09/829,389

(22) Filed: Apr. 9, 2001

(51) Int. Cl. G06F 12/14

(52) U.S. Cl. 713/200

(57) ABSTRACT

A method for determining authorization to use software components of a computer system or a controller using a unique hardware identification code is disclosed. An identification number is generated by an encoding algorithm from a hardware identification code and license information, optionally including additional information. Comparison of encoded and decoded identification numbers will permit or restrict access to the software components.

The present invention is directed to a method and system for preventing the unauthorized use of software components of a computer system or a controller by using a unique hardware identification code of a computer-readable data medium.

It is customary today to link software protection mechanisms with existing hardware components. One possibility is to enter the serial number of the hardware component permanently in the software at the time of delivery of the software license, and, therefore, the software cannot run on any other hardware component. This protection mechanism has the disadvantage that, in the event the hardware fails, the software cannot simply be transferred to another hardware component and run on the other component. Thus, a service call would be necessary and would require expensive hardware replacement.

Another option for linking software protection to hardware is to use a dongle, i.e., an additional hardware component. The dongle functions as a user access key to allow the software to run on the hardware that is connected to the dongle. If the dongle is connected to another hardware component, the software can then run on this other hardware component. However, the dongle can never be connected to more than one hardware component at the same time.

European Patent Application 940,743 A1 describes the use of dongles, in particular in laptops or notebook computers, to prevent unauthorized access to software programs.

The disadvantage of using dongles is that this additional hardware component is required, with its only purpose being to prevent unauthorized access. Dongles also have the disadvantage that multiple dongles are required for multiple licensors.

Therefore, an object of the present invention is to make available a reliable form of access protection for software components such that the protection mechanism by authorized users will not be restrictive. Advantageously, the present invention does not require any complicated hardware replacement during a service call, and the use of an additional hardware component as a dongle equivalent is not required.

An object of the present invention is achieved by the fact that an identification number, specific to a unique computer hardware identification code and license information, may be generated by means of an encoding algorithm, to clearly identify that particular combination of hardware and license information. The identification number is then transmitted in the form of the computer-readable data medium to the computer system or the controller on which the software components are running.

An important advantage of the present invention is that the unique hardware identification code (e.g., a serial number) is applied to the computer-readable data medium only by the manufacturer during manufacture and is written in an area of the data medium which can be subsequently read but no longer written. The hardware identification code is issued only once and is thus unique. Since the area containing the hardware identification code is only readable but not writeable, the unique hardware identification code cannot be transferred to another data medium of this type. Thus, it is impossible to clone the data medium. In addition to the hardware identification code, the computer-readable data medium contains other regions where useful data can be written. This feature constitutes another advantage of the present invention.

The computer-readable data medium carries information in its useful data region that can be used for the operation of a computer system or a controller. For the operation of controllers, the computer-readable data medium may contain in its useful data area, for example, not only complete run-time software and/or parameterization and configuration information, but it may also contain applications. The computer-readable data medium, with its useful data, is thus necessary for the operation of the computer system or the controller, and therefore is not an additional hardware component used solely as an access-protection mechanism.

Another advantage of the present invention is that, in the event a replacement part is necessary, continued use of the computer system and/or controller can be assured very easily and very quickly by replacing the computer-readable data medium, since the computer-readable data medium is not permanently connected to the licensee's primary hardware. For example, when a user has created a backup of the current computer-readable data medium, the operation of a controller can be restored very rapidly with the last valid parameterization and configuration backup of the current version of the run-time software. This backup, of course, contains only the same useful data as the primary computer-readable data medium. The hardware identification codes introduced into the computer-readable data medium by the manufacturer of said medium will, of course, vary and cannot be copied.

Another advantage of the present invention is the ease with which software components to be protected by the method of the invention can be marketed and distributed. The purchaser acquires a computer-readable data medium of the type as previously described containing an identification number generated using an encoding algorithm from the unique hardware identification code of the present computer-readable data medium and the desired scope of the license. When the computer-readable data medium is to be used, the software queries the computer system and/or control unit for the identification number, then checks the identification number and either issues or refuses access authorization. Thus, the user need not acquire the serial number of an existing hardware unit nor acquire an additional hardware component, e.g., a dongle, to allow the acquired software components to run. In addition, the user is spared a new license transaction in the event a replacement is needed, because the contents of the computer-readable data medium (except for the unique hardware identification code) are not fixed, and thus a simple replacement is possible.

In an embodiment of the present invention, additional information beyond the hardware identification code and license number may be used to generate the identification number. Bundling of hardware and software can be achieved very easily through the use of the identification number due to the fact that the encoding algorithm generating the identification number may also use other information, as input in addition to the hardware identification code and the license information. For example, the hardware identification code, license information and licensor may be bundled.

In another embodiment of the present invention, one or more identification numbers may be generated for one hardware identification code. It is thus possible for a user to obtain access authorizations for the software components of not only one licensor but also of several different licensors by acquiring a single computer-readable data medium. For the user, this embodiment constitutes the advantage that access authorization to software components of different licensors is obtained in a manner that is uniform and simple.

In another embodiment of the present invention, identification numbers may be stored in a readable and writeable area of the computer-readable data medium. This makes it very easy for software routines to access this information and check the respective licenses, i.e., for access authorization.

In another embodiment of the present invention, license information and/or additional information can be stored on the computer-readable data medium. This information can be read by the user and provides the user with a very easy and transparent overview of the possibilities for accessing the respective software components, which the user can then execute on a computer system or a controller.

In another embodiment of the present invention, a component that is necessary for the operation of the system may be used as the data medium. This feature ensures that no additional hardware identification code is needed for the protection mechanism. Not only is handling of the computer system or the controller facilitated, but also storage space and storage costs are saved.

In another embodiment of the present invention, a memory card may be used as the data medium. Memory cards are commonly used in controller and can be inserted easily into a slot in a computer provided for this purpose.

In another embodiment of this invention, an MMC memory card may be used as the data medium. MMC memory cards (the acronym MMC stands for multimedia card) are very suitable as carriers of information because of their size and shape. MMC memory cards are comparable in appearance to a small SIM card, such as those used in cellular telephones.

In another embodiment of this invention, the data medium may also be designed as a key containing this information. Access protection is increased by this bundling of hardware and the means of information technology.

One embodiment of the present invention is described with reference to the figures.

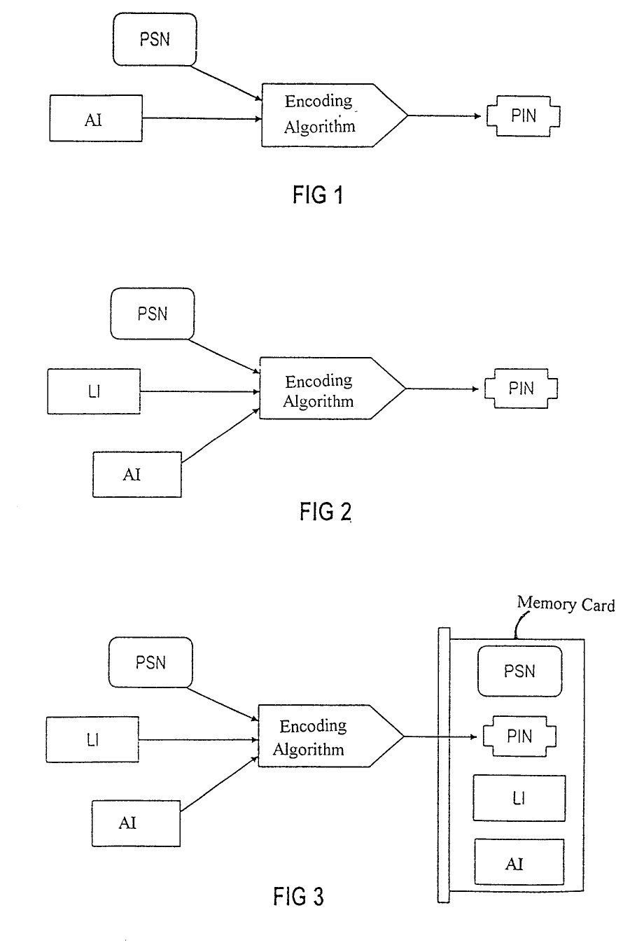

FIG. 1 shows the interaction of a hardware identification code and license information with an encoding algorithm, to yield a resultant identification number;

FIG. 2 shows the interaction of a hardware identification code, license information and additional information with an encoding algorithm, to yield a resultant identification number;

FIG. 3 shows the storage of an identification number in an MMC memory card;

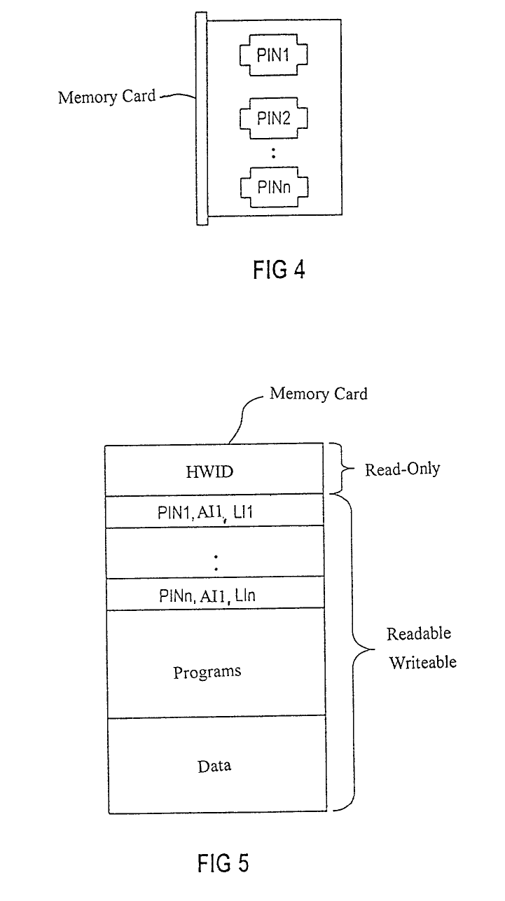

FIG. 4 shows an MMC memory card containing multiple identification numbers;

FIG. 5 shows the content structure of an MMC memory card;

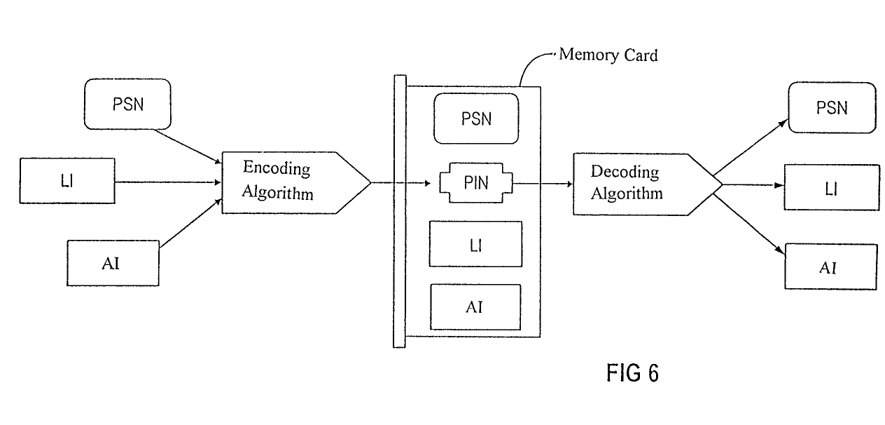

FIG. 6 shows the central position of an MMC memory card as a connecting link between an encoding algorithm and a decoding algorithm; and

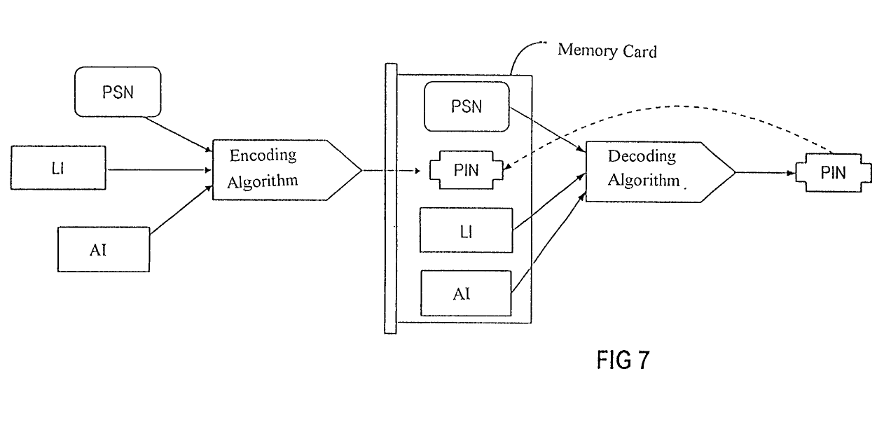

FIG. 7 shows the central position of an MMC memory card in another identification method.

In FIG. 1, the input/output performance of the encoding algorithm is illustrated in the form of an overview diagram. The encoding algorithm itself is regarded here as freely preselectable. Examples of such algorithms are disclosed by Gerd W. Wahner: Datensicherheit und Datenschutz [Data Safeguarding and Privacy Protection], 1993, Düsseldorf VDI Verlag [VDI Publishers], pages 219 through 241.

The left side of the diagram shows the inputs for the encoding algorithm, namely a hardware identification code PSN and the license information LI. The right side of the diagram shows the output, i.e., the result of the algorithm. The encoding algorithm supplies the identification number PIN as output. The inputs and outputs of the algorithm are illustrated by the self-explanatory direction of the arrows.

In FIG. 2, the diagram from FIG. 1 is supplemented by a third input parameter for the encoding algorithm, namely additional information AI. In FIG. 2, the identification number PIN is generated by the algorithm using hardware identification code PSN, license information LI and other additional information AI (e.g., a supplier identification). FIG. 2 shows the encoding algorithm as a dart-shaped block, with the direction of the arrows indicating the input/output flow of the algorithm.

FIG. 3 represents an expansion of FIG. 2. In the middle of FIG. 2, the encoding algorithm can again be seen as a dart-shaped block, with input parameters for the algorithm (hardware identification code PSN, license information LI and additional information AI) on the left half of the Figure. The right side of the Figure shows that the identification number PIN generated by the encoding algorithm is stored on an MMC memory card. The hardware identification code PSN, the license information LI, and the additional information AI are stored on the MMC memory card. The hardware identification code PSN is found on an area of the MMC memory card which can only be read and cannot be copied. The hardware identification code PSN, the license information LI and the additional information AI, however, are stored in an area of the MMC memory card that can be read and written. Bundling may be accomplished by packaging the identification number PIN, with the software license, the respective supplier information, and the unique hardware identification code PSN located on the bundled hardware. The additional information AI is optional in this situation.

During boot-up or operation of the software components to be protected by this invention, a software routine checks the system for the authorization. After boot-up of the software components, the authorization check is performed periodically. In FIG. 3, the directions of the arrows indicate the input/output of information flow for the encoding algorithm.

FIG. 4 shows that an MMC memory card may contain more than one identification number PIN1-PINn. Thus, an MMC memory card may contain a separate identification number PIN1-PINn for each licensor. Bundling of a license acquired with the unique hardware identification code PSN is accomplished with regard to each individual licensor through the use of each of these identification numbers PIN1-PINn. Typical licensors may include the original equipment manufacturer (OEM), i.e., hardware manufacturers who also supply software components that are to be protected in their systems or products.

FIG. 5 shows the content structure of an MMC memory card. The MMC memory card is divided into several blocks. The top block is the card identification block which is written by the manufacturer of the MMC memory card. This card identification block contains the unique hardware identification code PSN. This area can only be read (by the checking software) and cannot be copied. The next blocks contain the license information LI1-LIn, the additional information AI1-AIn, as well as the identification numbers PIN1-PINn generated by the encoding algorithm. In addition, an MMC memory card may also contain programs and data.

Except for the block which contains the unique hardware identification code PSN and which is only readable but not copyable, all the other blocks of an MMC memory card are readable, writeable and copyable.

FIG. 6 shows a central section of an MMC memory card which contains the hardware identification code PSN, the identification number PIN, the license information LI, as well as additional information AI. The left side of the figure shows how the identification number PIN is generated from the encoding algorithm. Input parameters for the encoding algorithm for generating the PIN include the hardware identification code PSN, the license information LI and any additional information AI. The additional information AI may be only optionally required by the encoding algorithm.

For access authorization, the identification number PIN on the MMC memory card is read by a software routine and checked with the help of a decoding algorithm. The decoding algorithm generates the unique hardware identification code PSN, the license information LI and the additional information AI (if any) from the identification number PIN. Access authorization with the help of the decoding algorithm may take place during the boot up of the system, i.e., the software components, and it may also take place periodically during the operation of the respective software components. If the PSN that is obtained with the decoding algorithm matches the PSN of the MMC memory card, use of the software component is allowed.

FIG. 7 shows another option for authorization. FIG. 7 shows a central section of an MMC memory card which contains the hardware identification code PSN, the identification number PIN, the license information LI and additional information AI. The left side of this figure shows how the identification number PIN is generated from the encoding algorithm. Input parameters for the encoding algorithm used in generating the PIN include the hardware identification code PSN, the license information LI, and additional information AI. Additional information AI is only optionally needed in this example. For access authorization, the identification number PIN is then generated from the hardware identification PSN, license information LI, and optionally additional information Al, by the previously used encoding algorithm. The resulting PIN is compared to the PIN on the MMC memory card (illustrated with a dotted arrow). If the two PINs match, use of the software component is allowed. This check is performed during system boot-up, as well as periodically during the operation of the respective software components.

What is claimed is:

1. A method for preventing unauthorized use of software components for a computer system or a control unit having a unique hardware identification, wherein an identification number for a distinct allocation of hardware identification and license information is generated from the invariant hardware identification code of a computer-readable data medium and additional license information by means of an encoding algorithm, and is sent in the form of the computer-readable data medium to the computer system or the control unit on which the software components run.

2. The method according to claim 1, wherein additional information is also used to generate the identification number.

3. The method according to claim 1, wherein one or more identification numbers can be generated for one hardware identification code.

4. The method according to claim 1, wherein the identification numbers are stored in a readable and writeable area of the computer-readable data medium.

5. The method according to claim 1, wherein license information and/or additional information is also stored on the computer-readable data medium.

6. The method according to claim 1, wherein a component that is already present for the operation of the system is used as the data medium.

7. The method according to claim 1, wherein a memory card is used as the data medium.

8. The method according to claim 1, wherein a multimedia memory card is used as the data medium.

9. The method according to claim 1, wherein the data medium may be designed as a key which contains information.
